(19) United States
(12) Patent Application Publication
(10) Pub. No.: US 2015/0110926 A1
(43) Pub. Date: Apr. 23, 2015

(54) SALT SUBSTITUTE

(71) Applicant: Compagnie Des Salins Du Midi et Des Salines De L'Est, Leval-lois-Perret (FR)

(72) Inventors: Karen Joly, Epalinges (CH); Delphine Mannina, Nogent-sur-marne (FR); Marie-Pierre Montaron, Quetigny (FR); Aude Yvon, Sartrouville (FR)

(21) Appl. No.: 14/395,980

(22) PCT Filed: Apr. 22, 2013
(86) PCT No.: PCT/FR2013/050889

§ 371 Date: Oct. 21, 2014

(30) Foreign Application Priority Data
Apr. 24, 2012 (FR) 1253735

(51) Int. Cl. A23L 1/237

(52) U.S. Cl. CPC A23L 1/2375; A23V 2002/00
USPC 426/74; 426/649

(57) ABSTRACT

The invention relates to a salt substitute comprising, in combination with sodium chloride:
72% to 87% by weight of potassium chloride,
10% to 20% by weight of magnesium sulphate, and
3% to 8% by weight of calcium sulphate.
   These mineral compounds are typically of marine origin. The invention also relates to the uses of the salt substitute according to the invention as table salt, or for the industrial preparation of food for human and/or animal consumption, offering the same technical functions as salt. The invention also relates to a method for manufacturing a salted product as well as a foodstuff comprising the salt substitute.

The invention relates generally to a salt substitute having a composition without NaCl allowing it to remain faithful to the taste of salt.

In particular, the invention relates to a salt substitute for use in the food industry or directly as a substitute for ordinary salt by the consumer.

Numerous scientific studies have demonstrated a correlation between excessive consumption of salt (NaCl) and cardiovascular diseases which are currently a real public health issue.

This overconsumption of salt is mainly due to changes in dietary habits, such as moving away from traditional cooking in favour of faster and more industrialised cooking, greater use of fast food restaurants, consumption of ready-made dishes, etc.

To reduce the risks related to overconsumption of salt, a proposal has been made to reduce the daily salt intake, using for example salt substitute compositions. These include in particular substitution salts with low sodium chloride content, but enriched with substantial quantities of potassium and magnesium salts.

The following has therefore been proposed in the prior art:
a) document GB 2237720 which describes a substitution salt containing, by weight of the final composition, 46.6% NaCl, 6.5% MgCl₂, 2.8% MgSO₄, 2.2% CaSO₄, 41.5% KCl, 0.10% MgBr₂ and 0.2% CaCO₃, or
b) the commercial composition comprising 33.3% NaCl+66.6% KCl.

However, the search for a substitution salt is difficult to implement. It involves finding compounds which best compensate for the taste deficit caused by the low proportion of sodium chloride while maintaining the technical functions of salt.

We observe that the salt substitute compositions of the prior art have limited taste qualities and fail to match the salting power of real salt. Typically, these compositions exhibit “false flavours”, such as bitterness, which alter the taste of salt.

Consequently, the search for a substitution salt to replace ordinary salt including less sodium chloride and exhibiting taste qualities and salting power equivalent to those of ordinary salt, remains of great interest.

The aim is in fact to obtain a salt substitute comprising a composition as close as possible to the sensory perception of salt in the form of table salt or as a complement in food matrices with a salty taste, a flavour-enhancing role, no false flavour and, preferably, the same technical functions as salt.

The invention therefore relates to a salt substitute comprising between 25% and 96% sodium chloride by total weight of the salt substitute excluding additives, from 0% to 4% additive(s) by total weight of the salt substitute, and a remaining composition comprising by total weight of this remaining composition:
72% to 87% potassium chloride,
10% to 20% magnesium sulphate, and
3% to 8%, preferably 7.5%, calcium sulphate.

Advantageously, this remaining composition consists of potassium chloride, magnesium sulphate and calcium sulphate. In the remainder of the document, the percentages are expressed by weight, unless otherwise specified or relative to the overall salt substitute, or relative to the composition excluding salt if specified.

Studies have been conducted to determine which compounds would be the best candidates to compensate for the sensory loss produced by the decrease in sodium chloride. The scope of the study has been limited to the minerals present in substantial quantities in seawater, i.e. NaCl, KCl, MgSO₄ CaSO₄, MgCl₂, CaCl₂ and K₂SO₄.

The prior art relating to the taste of minerals demonstrates that in a mixture of minerals, anions influence the taste by their size, i.e. the smaller the anion, the greater the intensity of the taste. Consequently, chlorides are considered as excellent candidates since their molecular weight is much less than that of sulphates

Consequently, before the invention, the prior art suggested an optimum formula composed exclusively of chlorides containing only, according to the above hypothesis, potassium chloride (KCl), magnesium chloride (MgCl₂) and or calcium chloride (CaCl₂). Such formulations were also proposed commercially before the invention. For example:
33.3% NaCl, 66% KCl,
60% NaCl, 21.4% KCl, 15.5% MgCl₂, 3.1% NH₄Cl, or
a composition consisting solely of NaCl and CaCl₂.

However, sensory analyses have revealed surprisingly that the best salt substitution solution was a mixture containing both chloride and sulphate as proposed by the invention. More particularly, it has been found that the taste of a formula containing potassium chloride, magnesium sulphate and calcium sulphate, in special proportions, was better than that of formulae composed exclusively of chlorides.

It would appear that in this mixture, the existence of taste interactions between the mineral salts eliminates false flavours.

Moreover, this composition comprises minerals present naturally in seawater, such as NaCl, KCl, MgSO₄ and CaSO₄.

The salt substitute may also include small quantities of compounds with little or no taste, such as clay resulting from the collection method, etc.

According to a preferred embodiment of the invention, the salt substitute comprises less than 90% NaCl, preferably less than 80% NaCl.

Typically, sodium chloride comes from the sea, underground rock salt deposits or natural brine.

According to the various standards on food grade salt, the sodium chloride (NaCl) content should not be less than 97% of the dry extract, excluding additives.

An exception is made for grey sea salt, however, the minimum degree of purity tolerated being 94%, the impurities being mainly clay resulting from the collection method, magnesium, calcium and potassium salts as sulphate or chloride.

Concerning white sea salts, the insoluble compounds are present in much lower quantities, the NaCl degree of purity, excluding additives, reaching up to 99.8

According to a preferred composition, the salt substitute of the invention preferably comprises between 50% and 95% sodium chloride.

According to an optional characteristic of the invention, the remaining composition comprises by total weight of this remaining composition:
76% to 84% potassium chloride,
12% to 18% magnesium sulphate, and
4% to 6% calcium sulphate.

Advantageously, the remaining composition comprises by total weight of this remaining composition:
78% to 82% potassium chloride,
13.5% to 16.5% magnesium sulphate, and
4.5% to 5.5% calcium sulphate.

According to a preferred embodiment, the remaining composition comprises by total weight of this remaining composition:
82% to 86% potassium chloride,
10% to 12.5% magnesium sulphate, and
4.5% to 5.5% calcium sulphate.

When this composition consists of individual crystals (like salt particles), such a composition can be used to obtain a salt substitute having improved flowability and being less likely to cake.

According to an optional characteristic of the invention, each additive belongs to the group consisting of iodine compounds, anticaking agents, flowability agents, potassium fluoride and sodium nitrite, alone or in mixtures.

The term “additive” means the technical additives and the nutrients, typically iodine.

Iodine is added in the form of potassium iodide, sodium iodide, sodium iodate or potassium iodate. The quantities of iodine vary depending on the country and generally depend on national regulations (from 15 to over 100 mg/kg). Iodine is distributed via salt to reduce iodine deficiencies in the population and thus contribute, amongst other things, to the proper functioning of the thyroid.

Potassium fluoride is incorporated in salt to reduce fluorine deficiencies in the population. The quantity to be incorporated is set by national regulations, for example in France the quantity is set at 250 mg/kg. Salt is fluorinated since fluoride helps protect teeth from demineralisation.

“Anti-caking agents” means substances used to prevent agglomeration of salt crystals, and thus prevent solidification.

Preferably, the anticaking agents are selected from the group consisting of sodium ferrocyanide (Na₄Fe(CN)₆), potassium ferrocyanide (Na₄Fe(CN)₆) and calcium ferrocyanide (Ca₂Fe(CN)₆).

“Flowability agents” means agents that improve the flowability of the salts, either to make the salt flow more easily through the holes of a salt cellar or to facilitate its use on an industrial machine.

Preferably, the flowability agents are selected from the group consisting of calcium carbonates (CaCO₃/Ca(HCO₃)₂), sodium carbonates (Na₂CO₃/NaHCO₃), magnesium carbonates (MgCO₃/4MgCO₃Mg(OH)₂), magnesium oxide (MgO) and silicon dioxide (SiO₂, nH₂O). A mixture of magnesium carbonate and magnesium oxide is preferred, especially in respective proportions by weight of 60:40, ±5%. For formulations intended for individual use (table salt), this flowability agent is advantageously added in proportions ranging from 0.8% to 1.2% by weight, typically about 1%. For formulations intended for industrial uses, this proportion may be less (for example this proportion may range from 0.25% to 0.75%).

Those skilled in the art know how to unambiguously determine the compounds present in a salt composition which are either anticaking agents or flowability agents.

Some of these additives are used in quantum satis (necessary and sufficient quantity), others at a maximum rate of 1%.

According to an optional characteristic of the invention, the total quantity of additive(s) is less than 3%, even 2%, preferably 1.5% by total weight of the salt substitute.

Preferably, each additive is used in proportions ranging from 0.0005% (trace) to 1 by total weight of the salt substitute.

Sodium nitrite is an additive added to salt for cooked meats or animal feed. It has a technical function of preservative, but it also allows the development of colour and flavour. Apart from these two industrial applications, sodium nitrite is not incorporated in salt.

In practice, the sodium nitrite content in salts may vary from 0.45% to 1.8%, depending on customer requirements and the country.

According to another variant of the invention, additives are conventionally composed of the above-mentioned specific chemical compounds, excluding other compounds.

None of these additives is mandatory. They are all optional in the composition.

Furthermore, the use of these additives in a salt composition does not substantially alter the taste.

According to an optional characteristic of the invention, the salt substitute consists substantially of crystals comprising at least 50% by total weight of the salt substitute, in the form of crystals of granulometry (measured by screening) of between 0.1 mm and 6 mm diameter.

Preferably, at least 50% by total weight of the salt substitute is in the form of crystals of granulometry between 0.1 mm and 3 mm diameter.

Preferably, at least 50% by total weight of the salt substitute is in the form of crystals of granulometry between 0.1 mm and 2 mm diameter.

Advantageously, the salt substitute comprises at least 50% by weight in the form of crystals of granulometry between 0.1 mm and 1 mm diameter, preferably from 0.2 mm to 0.5 mm diameter.

According to a special preferred aspect of the invention, the constituents of the group consisting of sodium chloride, potassium chloride, magnesium sulphate and calcium sulphate, are of marine origin.

This invention also relates to a table salt substitute comprising all the preceding characteristics.

The salt substitute according to the invention may also consist of a mixture comprising or consisting of potassium chloride, magnesium sulphate and calcium sulphate in the above-mentioned proportions as “remaining composition”. Such a substitute can be used to replace some of the salt added when preparing a food or a foodstuff. For example, it may replace up to 75% by weight of the salt used in the matrix of said foodstuff. Preferably it replaces up to 50% by weight of the salt and in particular up to 35% by weight of the salt present in this food or foodstuff. Advantageously, it replaces about 25% by weight of the salt present in this food or foodstuff.

This invention also relates to a method for manufacturing a salted product, in particular a product, or foodstuff, comprising the addition to said product of a salt substitute according to the invention.

The salt substitute according to the invention, whether or not it comprises sodium chloride (salt), may be included or amalgamated in salted food products, such products being themselves an object of the invention.

This invention also relates to the use, either simultaneous, separate or spread over time, of potassium chloride, magnesium sulphate and calcium sulphate in combination with salt (NaCl) for the preparation of foodstuffs. Preferably, the respective proportions of these three products are as described in the above-mentioned “remaining compositions” and/or the following examples.

This invention also relates to the use of a salt substitute according to the invention for the preparation, in particular industrial, of food for human and/or animal consumption. It therefore offers the same technical functions as salt, technical functions which may vary depending on the matrices (preservation, texture, colour, etc.).

For example, the salt substitute according to the invention can be used to maintain the taste of food, mainly for the manufacture of ready-to-eat meals, soups, aperitif biscuits, etc.

This invention also relates to the use of a salt substitute according to the invention, as a preservative of food, such as cheeses, cooked meats and for salting fish, meat, etc.

It will be easier to understand the invention on reading the description below, given as an example.

### EXAMPLE 1

### Comparative Study of the Taste of the Salt Substitute According to the Invention Compared with Substitutes of Higher Chloride Content

The surprising discovery was made that the taste of a salt of low sodium chloride content and enriched in salts KCl, MgSO₄, CaSO₄ was very close to that of conventional salt and that there were very few false flavours despite the sulphate content.

Products tested:

F0 (salt): 100% NaCl

F1 (comparative—100% chlorides): 50% NaCl, 46% KCl, 4% MgCl₂

F2 (comparative—94.5% chlorides): 50% NaCl, 44.5% KCl, 5.5% CaSO₄

F3 (composition according to the invention—90% chlorides): 50% NaCl, 40 KCl, 7.5% MgSO₄, 2.5% CaSO₄

Matrices used:
VITALIA tomato juice with no added salt in which the products tested were incorporated at 0.6% by weight.
Mousline mashed potato with no added salt in which the products tested were incorporated at 0.6% by weight.

Number of participants: 101

Overall Assessment Rating Scale:

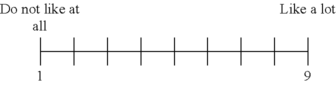

Salt Resemblance Rating Scale:

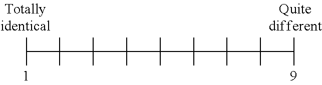

### a) Tomato Juice Overall Assessment

| | F0 | F1 | F2 | F3 |
|---|---|---|---|---|
| Mean | 5.93 | 4.75 | 4.93 | 5.33 |
| Standard | 2.02 | 2.3 | 2.13 | 2.05 |
| deviation | | | | |

Formula F3 according to the invention obtains the highest overall assessment rating in tomato juice, after formula F0 with conventional salt. It obtains a better rating than formulae F1 and F2 which contain a higher proportion of chlorides.

### b) Mashed Potato Overall Assessment

| | F0 | F1 | F2 | F3 |
|---|---|---|---|---|
| Mean | 6.45 | 5.56 | 5.2 | 5.64 |
| Standard | 1.82 | 1.99 | 1.86 | 2.05 |
| deviation | | | | |

Formula F3 according to the invention obtains the highest overall assessment rating in mashed potato, after formula F0 with conventional salt. It obtains a better rating than formulae F1 and F2 which contain a higher proportion of chlorides.

c) Resemblance with Salt Control (in Tomato Juice)

| | F1 | F2 | F3 |
|---|---|---|---|
| Mean | 4.63 | 4.05 | 3.98 |
| Standard | 3.19 | 3.25 | 3.07 |
| deviation | | | |

Tomato juice seasoned with formula F3 according to the invention resembles most tomato juice with salt.

Results/Conclusions: formula F3 according to the invention has the best taste of the three formulae tested in tomato juice and mashed potato. In addition, it is the formula closest to the taste of salt.

Thus, this first example confirms that the salt substitute according to the invention with 50% NaCl, 40% KCl, 7.5% MgSO₄ and 2.5% CaSO₄ is better than the formulae containing more chlorides.

### EXAMPLE 2

### Triangular Test Between Salt Substitute F5 According to the Invention and a Commercial Composition of Salt Substitute F4, Each Comprising 33.3% NaCl

F4 (comparative): 33.3% salt+66.6% KCl.

F5 (composition according to the invention): 33.3% salt+53.3% KCl+10 MgSO₄+3.4% CaSO₄.

Matrix used: VITALIA tomato juice with no added salt in which the products tested were incorporated at a concentration of 6 g/L.

Methodology:

Triangular tests were conducted with these two products (F4, F5) on 24 participants. Each time, the participants tested three samples, two identical and one different.

These tests were conducted according to well-established rules, using the following 6×4 forms: AAB×4; ABB×4; BAA×4; BBA×4; ABA×4; BAB×4, to organise the draw. (A=F5) (B=F4).

The participants had to answer two questions:

Which sample do you think is different?

Which sample do you prefer?

Results:

Out of the 24 participants, 7 managed to identify the sample which differed from the other two.

Looking at the results of the 7 “correct answers”, we see that the 7 participants preferred the tomato juice with composition F5.

Conclusion:

In these tests, it is interesting to note that the results of the preference of the 7 participants who rightly made the distinction are all identical, preferring the salt substitute according to the invention.

In this respect, the preference of 7 consumers out of 7, i.e. 100% of the consumers who expressed a difference is highly significant, leading us to conclude that the salt substitute according to the invention has a better taste (or fewer false flavours) in the opinion of the consumers able to perceive a difference.

### EXAMPLE 3

### Comparative Study of Taste of Salt Substitutes According to the Invention with Different Sodium Chloride Contents Compared with Salt, in a Bread Recipe

Products tested:

F0 (salt): 100% NaCl,

F6 (composition according to the invention): 85% NaCl, 12% KCl, 2.25% MgSO₄, 0.75% CaSO₄,

F7 (composition according to the invention): 70% NaCl, 24% KCl, 4.5% MgSO₄, 1.5% CaSO₄.

Matrices used: bread made using the manufacturing diagram of the BIPEA NF V03-716 method. Salting product content: 18 g/kg flour.

Number of Participants: 61

### a) Overall Assessment of the Bread Stick:

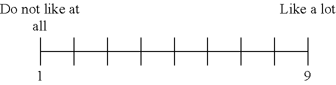

| | Overall assessment rating | | |
|---|---|---|---|
| | F0 | F6 | F7 |
| Mean | 6.23 | 6.41 | 6.58 |
| Standard | 1.92 | 2.05 | 1.77 |
| deviation | | | |

### b) Bread Stick Texture Rating:

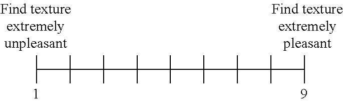

| | Bread stick texture rating | | |
|---|---|---|---|
| | F0 | F6 | F7 |
| Mean | 5.35 | 5.92 | 6.07 |
| Standard | 2.06 | 1.96 | 2.09 |
| deviation | | | |

Conclusion: these results show that bread salted with the compositions according to the invention (F6 and F7) is even perceived more favourably than bread with conventional salt.

### EXAMPLE 4

### Triangular Tests Between the Salt Substitute According to the Invention and Salt in a Camembert Cheese Recipe

Products tested:

F0 (salt): 100% NaCl,

F6 (composition according to the invention): 85% NaCl, 12% KCl, 2.25 MgSO₄, 0.75% CaSO₄,

F7 (composition according to the invention): 70% NaCl, 24% KCl, 4.5% MgSO₄, 1.5% CaSO₄.

Matrices used: camemberts in which the salting products were incorporated at the rate of 2% by weight.

Number of participants: 61

### a) F0/F6 Discrimination Test Result:

Out of the 61 consumers surveyed, only 21 found the piece of camembert different from the other two. Out of these 21 consumers, 20 indicated that this choice was made randomly. This result shows that the true proportion of consumers able to differentiate between the two camemberts (estimated at 1.6%) is low and does not allow us to conclude that there is a significant difference between the salting products.

### b) F0/F7 Discrimination Test Result:

Out of the 61 consumers surveyed, only 23 found the piece of camembert different from the other two. Out of these 23 consumers, 19 indicated that this choice was made randomly. These results show that the true proportion of consumers able to differentiate between the two camemberts (estimated at 6.5%) is low and does not allow us to conclude that there is a significant difference between the salting products.

Results/Conclusions:

These tests demonstrate that most consumers, in the case of camembert, are unable to distinguish between the salt substitute according to the invention and conventional salt.

### EXAMPLE 5

### Checking the Technical Functions of Salt Substitutes According to the Invention, in a Bread Recipe

Products tested:

F0 (salt): 100% NaCl,

F6 (composition according to the invention): 85% NaCl, 12% KCl, 2.25 MgSO₄, 0.75% CaSO₄,

F7 (composition according to the invention): 70% NaCl, 24% KCl, 4.5% MgSO₄, 1.5% CaSO₄.

Matrix used: bread made using the manufacturing diagram of the BIPEA NF V03-716 method. Salting product content: 18 g/kg flour.

### a) Tests Using the Chopin Alveograph:

The Chopin alveograph is a measurement tool commonly used in baking to evaluate the behaviour of the dough.

| | F0 | F6 | F7 |
|---|---|---|---|
| Deformation | 263 | 255 | 248 |
| energy W | | | |
| Tenacity P | 108 | 105 | 103 |
| Extensibility L | 65 | 66 | 65 |
| P/L | 1.66 | 1.59 | 1.58 |

These results show that there is no statistically significant difference in dough behaviour between a flour in which conventional salt has been incorporated and a flour with the compositions according to the invention.

### b) Evaluation of the Main Technological Parameters of the Finished Product:

| | | F0 | F6 | F7 |
|---|---|---|---|---|
| Length of dough lumps (cm) | | 36.4 | 36.4 | 36.5 |
| Volume (cm³) | | 1647.5 | 1705.0 | 1682.5 |
| Weight (g) | | 273.8 | 273.5 | 273.8 |
| Section (cm) | | 7.85 | 7.80 | 7.60 |
| Softness | | Good (10) | Good (10) | Good (10) |
| Crust colour | L | 56.99 | 53.58 | 51.97 |
| | a | 10.87 | 11.47 | 11.92 |
| | b | 34.93 | 32.42 | 31.68 |
| Crumb colour | L | 76.89 | 75.19 | 74.9 |
| | a | −3.67 | −3.78 | −3.61 |
| | b | 22.27 | 22.68 | 22.96 |

These results show that there is no difference between bread made with conventional salt and bread made with the compositions according to the invention.

The composition according to the invention therefore has the same technological properties in bread as conventional salt, both in terms of dough elasticity and colour of the crust or crumb.

c) Checking the Preservation Role of the Compositions According to the Invention in a Bread Recipe Compared with Conventional Salt:

The preservation was evaluated by monitoring the weight losses at D+1, D+2 and D+3.

| | Mean weight | | |
|---|---|---|---|
| | F0 | F6 | F7 |
| D | 273.5 | 273.5 | 273.75 |
| D + 1 | 255.25 | 255.5 | 256.25 |
| D + 2 | 237 | 238 | 238.75 |
| D + 3 | 220.75 | 222.25 | 222.5 |

Comparison of the weight losses between bread with conventional salt (F0) and the two breads with a salt substitute according to the invention (F6 and F7) shows that the salt substitute has the same preservative properties in bread as salt.

Conclusions: these tests in a bread recipe show that the salt substitute according to the invention has the same technological properties as conventional salt.

### EXAMPLE 6

### Checking the Technological Roles of Salt Substitutes According to the Invention, in a Camembert Recipe

Products tested:

F0 (salt): 100% NaCl,

F6 (composition according to the invention): 85% NaCl, 12% KCl, 2.25 MgSO₄, 0.75% CaSO₄,

F7 (composition according to the invention): 70% NaCl, 24% KCl, 4.5% MgSO₄, 1.5% CaSO₄.

Matrix used: camemberts in which the salting products were incorporated at the rate of 2%.

Results:

| | Unit | F0 | F6 | F7 |
|---|---|---|---|---|
| TDE | g/100 g | 46.92 | 48.43 | 48.48 |
| F | g/100 g | 21.50 | 22.50 | 22.63 |
| F/D | % | 45.82 | 46.46 | 46.67 |
| MFFB | % | 67.62 | 66.55 | 66.58 |
| Ca | mg/100 g | 569 | 554 | 569 |
| Ca/FFDE | % | 2.24 | 2.14 | 2.20 |
| TNCM | g/100 g | 20.9 | 21.8 | 21.6 |
| SN/TN | % | 35.0 | 33.1 | 33.3 |
| NPN/TN | % | 18.3 | 17.2 | 16.7 |
| NH₃ | mg/100 g | 153.5 | 153.0 | 151 |
| Lactate L | mg/100 g | 29 | 41 | 41 |
| Lactate D | mg/100 g | 5 | 4 | 6 |
| Lactate | mg/100 g | 34 | 44 | 47 |
| Chlorides | g/100 g | 1.30 | 1.28 | 1.31 |
| Crust | g/100 g | 1.23 | 1.27 | 1.22 |
| chlorides | | | | |
| NaCl via Cl | g/100 g | 2.11 | | |
| NaCl via Na | g/100 g | 2.09 | 1.84 | 1.56 |
| Na | g/100 g | 0.82 | 0.73 | 0.62 |
| Mg | g/kg | 0.24 | 0.26 | 0.34 |
| K | g/kg | 1.23 | 2.57 | 4.15 |

Key:
TDE: Total dry extract
F/D: Fat/Dry
MFFB: Moisture on a fat-free basis
FFDE: Fat-free dry extract
SN: Soluble nitrogen
TN: Total nitrogen
NPN: Non-proteic nitrogen
F: Fat
TNCM: Total nitrogen-containing matter

The type of salt has little effect on the development of surface flora during ripening. The flora appears at the same refining stage and its development is globally similar for the three types of salt.

The water activity (a_{w}) is not statistically different in the camemberts made using the different types of salt. This result suggests similar behaviour with respect to pathogenic alteration bacteria.

Lastly, proteolysis of the camemberts is not significantly influenced by the salt substitute, whether in terms of primary proteolysis or fine proteolysis (ammonia production in particular).

Conclusion: These results have allowed us to demonstrate that the compositions according to the invention had the same technical function as salt in camembert.

### EXAMPLE 7

### Checking the Technical Functions of Salt Substitutes According to the Invention, in a Frankfurter Sausage Recipe

Comparative tests were conducted on the use of salt substitutes according to the invention in sausage recipes.

The sausages have a constant lipid content of 25% and are made using four series of salting products:
C=control 100% sodium chloride.
R35=test with 35% reduction in sodium chloride.
S25=test with 25% substitution of sodium chloride by a mixture of 80 potassium chloride, 15% magnesium sulphate and 5% calcium sulphate.
S35=test with 35% substitution of sodium chloride by a mixture of 80 potassium chloride, 15% magnesium sulphate and 5% calcium sulphate.

Three repetitions of fifteen sausages each are conducted for each series, each repetition comprising the 4 series C, R35, S25 and S35, made using the same base of raw materials. The formulation of its products is shown in Table 1 below:

TABLE 1
formulations of the 4 series of fine-textured sausages:

| Content (%) | C | R35 | S25 | S35 |
|---|---|---|---|---|
| Shoulder | 52.96 | 53.30 | 52.96 | 52.96 |
| Back fat | 24.98 | 25.14 | 24.98 | 24.98 |
| Ice | 19.99 | 20.11 | 19.99 | 19.99 |
| Nitrited salt | 1.17 | 1.17 | 1.17 | 1.17 |
| Dextrose | 0.22 | 0.22 | 0.22 | 0.22 |
| Erythorbate | 0.04 | 0.04 | 0.04 | 0.04 |
| Ordinary SC | 0.63 | 0.00 | 0.18 | 0.00 |
| Mixture composed (by weight) | 0.00 | 0.00 | 0.45 | 0.63 |
| of 80% KCl, 15% MgSO₄ and 5% | | | | |
| CaSO₄ | | | | |
| TOTAL | 100 | 100 | 100 | 100 |

SC: Salt concentration: “Ordinary” NaCl, i.e. without the addition of nitrite. The salt reductions take into account the total quantity of salt (ordinary and nitrited).

The technological efficiency (weight variation), texture (firmness), colour and overall sensory evaluation were tested. While no significant difference was observed between the control and sausages S25 and S35, sausages R35 proved significantly poorer in terms of technological efficiency, texture and sensory evaluation.

### EXAMPLE 8

### Formulation of a Salt Substitute for Salt Cellar

An example of salt substitute especially suitable for distribution from a salt cellar is a composition in the form of crystals whose size or granulometry, measured by screening, generally lies in the range from 200 μm to 500 μm and whose composition in total weight of salt substitute is as follows:
50% NaCl,
41% KCl,
5.5% MgSO4,
2.5% CaSO4,
1% DC4 (a mixture of magnesium carbonate and oxide in respective proportions 60:40 by weight); and
ferrocyanide as trace (0.0005%).

This formulation exhibits good flowability and is especially suitable for distribution of the salt substitute from a salt cellar, i.e. a container whose lid is pierced with a series of holes allowing controlled flow of a small quantity of substitute, usually onto food. This formulation offers in particular the advantage of preserving, at least partially, the flowability of crystals during their storage. This type of product is especially suitable for use as table salt substitute.

### EXAMPLE 9

### Formulation of Salt Substitute in the Form of Particles and Exhibiting Low Caking

Another example of salt substitute allowing easy transport and storage is a composition in the form of crystals whose size or granulometry, measured by screening, generally lies in the range from 100 μm to 900 μm and whose composition in total weight of salt substitute is as follows:
50% NaCl,
40% KCl,
7% MgSO4,
2.5% CaSO4,
0.5% DC4; and
ferrocyanide as trace (0.0005%).

This formulation offers in particular the advantage of very low agglomeration of the particles during storage and therefore good flowability. This type of product is therefore especially suitable for use, automated or not, in the food industry.

1. A salt substitute comprising between 25% and 96% sodium chloride by total weight of the salt substitute excluding additives, from 0% to 4% additive(s) by total weight of the salt substitute, and a remaining composition comprising by total weight of this remaining composition:
72% to 87% potassium chloride,
10% to 20% magnesium sulphate, and
3% to 8% calcium sulphate.

2. The salt substitute according to claim 1, comprising between 50% and 95% sodium chloride, by total weight of the salt substitute excluding additives.

3. The salt substitute according to claim 1, wherein the remaining composition comprises by total weight of this remaining composition:
76% to 84% potassium chloride,
12% to 18% magnesium sulphate, and
4% to 6% calcium sulphate.

4. The salt substitute according to claim 1, wherein the remaining composition comprises by total weight of this remaining composition:
82% to 86% potassium chloride,
10% to 12.5% magnesium sulphate, and
4.5% to 5.5% calcium sulphate.

5. The salt substitute according to claim 1, wherein each additive belongs to the group consisting of iodine compounds, anticaking agents, flowability agents, potassium fluoride and the nitrites, and their mixtures.

6. The salt substitute according to claim 1, wherein the quantity of additive(s) is less than 2% by total weight of the salt substitute.

7. The salt substitute according to claim 1, wherein all the constituents of the group consisting of sodium chloride, potassium chloride, magnesium sulphate and calcium sulphate, are of marine origin.

8. A salt substitute comprising the following composition:
72% to 87% by weight of potassium chloride,
10% to 20% by weight of magnesium sulphate, and
3% to 8% by weight of calcium sulphate.

9. The salt substitute according to claim 8, wherein the composition comprises:
78% to 82% by weight of potassium chloride,
13.5% to 16.5% by weight of magnesium sulphate, and
4.5% to 5.5% by weight of calcium sulphate.

10. The salt substitute according to claim 1, in the form of crystals of granulometry between 0.1 mm and 6 mm diameter, preferably from 0.2 mm to 0.5 mm diameter.

11. A table salt substitute comprising a salt substitute according to claim 1.

12. Use of the salt substitute according to claim 1, for the industrial preparation of food for human and/or animal consumption.

13. A method for manufacturing a salted product, in particular a food product, comprising the addition to said product of a salt substitute according to claim 1.

14. Use, either simultaneous, separate or spread over time, of potassium chloride, magnesium sulphate and calcium sulphate in respective proportions described in claim 8, in combination with sodium chloride for the preparation of foodstuffs.

15. A salted food product comprising a salt substitute as in claim 1.
